(19) United States
(12) Patent Application Publication
(10) Pub. No.: US 2010/0001988 A1
(43) Pub. Date: Jan. 7, 2010

(54) LIQUID CRYSTAL DISPLAY WITH IMPROVED APERTURE RATIO AND RESOLUTION

(76) Inventor: Dong-Gyu KIM, Yongin-si (KR)

Correspondence Address: Haynes and Boone, LLP;IP Section, 2323 Victory Avenue, SUITE 700, Dallas, TX, 75219, US

(21) Appl. No.: 12/492,057

(22) Filed: Jun. 25, 2009

(30) Foreign Application Priority Data
Jul. 3, 2008 (KR) 10-2008-0064403

(51) Int. Cl. G09G 3/36; G09G 5/00

(52) U.S. Cl. 345/214; 345/87

(57) ABSTRACT

A liquid crystal display device having a high aperture ratio and a high resolution is provided. The liquid crystal display device includes a first display panel having dot pixels each of which is divided into sub pixels arranged in a 2×2 matrix, a second display panel having cutout patterns each of which corresponds to the centers of the each sub pixel, and a liquid crystal layer interposed between the first display panel and the second display panel.

### CROSS-REFERENCE TO RELATED APPLICATION

This application claims priority from Korean Patent Application No. 10-2008-0064403 filed on Jul. 3, 2008 in the Korean Intellectual Property Office, the disclosure of which is incorporated herein by reference in its entirety.

### BACKGROUND OF THE INVENTION

1. Field of the Invention

The present invention relates to a liquid crystal display device, and more particularly, to a liquid crystal display device having a high aperture ratio and a high resolution.

2. Description of the Related Art

Liquid crystal display devices include liquid crystal panels having a first display panel provided with pixel electrodes, a second display panel provided with a common electrode, and a layer of liquid crystal material that is injected between the first display panel and the second display panel, wherein the liquid crystal material has dielectric anisotropy. A voltage is applied to form an electric field between the pixel electrodes and the common electrode, and the strength of the electric field is adjusted to control the amount of light passing through each of the pixel electrodes of the liquid crystal panel, thereby displaying a desired image.

In a vertical-alignment-mode liquid crystal display device, when no electric field is applied, the liquid crystal molecules are aligned such that their directors are vertical, that is to say the directors are perpendicular to the first display panel and the second display panel. The vertical alignment mode has been drawing attention because it can achieve a high contrast ratio and a wide viewing angle. In addition, methods of dividing each dot pixel into a plurality of sub pixels, forming a switching element in each sub pixel, and individually applying a voltage to each sub pixel have been proposed.

In the vertical-alignment-mode liquid crystal display device in which each dot pixel is divided into a plurality of sub pixels, amorphous silicon (a-Si) thin film transistors are used as the switching elements. Thus, in an effort to meet the increasing demand for high quality display devices that can be viewed from a wide angle, a liquid crystal display device having a high aperture ratio and a high resolution is needed.

### SUMMARY OF THE INVENTION

Aspects of the present invention provide a liquid crystal display device having a high aperture ratio and a high resolution.

However, the aspects, features and advantages of the present invention are not restricted to the ones set forth herein. The above and other aspects, features and advantages of the present invention will become more apparent to one of ordinary skill in the art to which the present invention pertains by referencing a detailed description of the present invention given below.

According to an aspect of the present invention, there is provided a liquid crystal display device including: a first display panel having dot pixels each of which is divided into sub pixels arranged in a 2×2 matrix; a second display panel having cutout patterns each of which is positioned to correspond to the center of the each sub pixel; and a liquid crystal layer interposed between the first display panel and the second display panel.

According to another aspect of the invention, there is provided a liquid crystal display device including: dot pixels each of which is divided into sub pixels arranged in a 2×2 matrix; thin film transistors that turn on the sub pixels; and contact holes electrically connecting the thin film transistors to pixel electrodes of the sub pixels. The contact holes are formed at the centers of the sub pixels.

According to another aspect of the invention, there is provided a liquid crystal display device including: dot pixels each of which is divided into sub pixels arranged in a 2×2 matrix; a common electrode facing pixel electrodes of the sub pixels and including cutout patterns that are formed in locations that correspond to the centers of the sub pixels; a data driver applying a data voltage to the pixel electrodes of the sub pixels; and a liquid crystal layer interposed between the pixel electrodes of the sub pixels and the common electrode. The dot pixels are classified into positive dot pixels and negative dot pixels that are alternately turned on, thereby performing inversion driving. A maximum liquid crystal voltage that allows the liquid crystal molecules to be fully turned on is lower than a maximum value of the data voltage, and a common voltage applied to the common electrode has a swing voltage that is lower than the maximum liquid crystal voltage.

### BRIEF DESCRIPTION OF THE DRAWINGS

The above and other aspects and features of the present invention will become more apparent based on the following detailed description of exemplary embodiments thereof taken with reference to the attached drawings, in which:

FIG. 1 is a block diagram illustrating a liquid crystal display device according to an exemplary embodiment of the invention;

FIG. 2 is an equivalent circuit diagram illustrating one dot pixel Dot PX of the liquid crystal panel shown in FIG. 1;

FIG. 3 is an equivalent circuit diagram illustrating one of the sub pixels R_PX, G_PX, B_PX, and W_PX of the dot pixel Dot PX shown in FIG. 2;

FIG. 4 is a layout diagram illustrating one dot pixel Dot PX of the liquid crystal panel shown in FIG. 1;

FIG. 5 is a cross-sectional view illustrating a portion of sub pixel R_PX taken along the line V-V′ of FIG. 4;

FIG. 6 is a diagram illustrating an inversion driving method of the liquid crystal panel shown in FIG. 1;

FIG. 7 is a timing chart illustrating a method of driving positive dot pixels and negative dot pixels shown in FIG. 6; and

FIG. 8 is a timing chart illustrating another method of driving the positive dot pixels and the negative dot pixels shown in FIG. 6.

### DETAILED DESCRIPTION OF THE EXEMPLARY EMBODIMENTS

The present invention will now be described more fully with reference to the accompanying drawings, in which exemplary embodiments of the invention are shown. The invention may, however, be embodied in many different forms and should not be construed as being limited to the embodiments set forth herein. Rather, these embodiments are provided so that this disclosure will be thorough and complete, and will fully convey the concept of the invention to those skilled in the art.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Like numbers refer to like elements throughout. As used herein the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

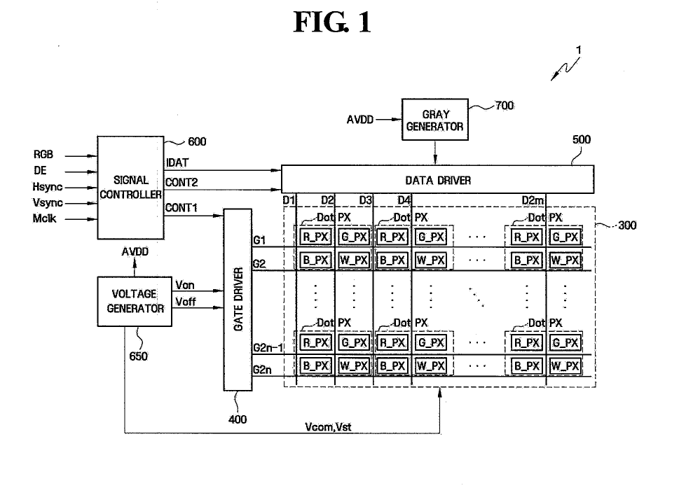

FIG. 1 is a block diagram illustrating a liquid crystal display device according to an exemplary embodiment of the invention.

Referring to FIG. 1, a liquid crystal display device 1 may include a liquid crystal panel 300, a signal controller 600, a gate driver 400, a data driver 500, a voltage generator 650, and a gray voltage generator 700.

The liquid crystal panel 300 may include a plurality of dot pixels Dot PX, a plurality of gate lines G1 to G2n (n is a natural number), and a plurality of data lines D1 to D2m (m is a natural number). The dot pixels Dot PX are arranged in an n×m matrix Each of the dot pixels Dot PX may be divided into four sub pixels, a red sub pixel R_PX, a green sub pixel G_PX, a blue sub pixel B_PX, and a white sub pixel W_PX that are arranged in a 2×2 matrix, as shown in FIG. 1. The red sub pixel, green sub pixel, blue sub pixel and the white sub pixel may hereinafter be referred to respectively as an R sub pixel R_PX, a G sub pixel G_PX, a B sub pixel B_PX, and a W sub pixel W_PX.

The gate lines G1 to G2n extend parallel to each other substantially in a row direction, and the data lines D1 to D2m extend parallel to each other substantially in a column direction. The sub pixels R_PX, G_PX, B_PX, and W_PX may be defined at intersections of the gate lines G1 to G2n and the data lines D1 to D2m. The gate driver 400 outputs gate signals to the gate lines G1 to G2n, and the data driver 500 outputs data voltages to the data lines D1 to D2m. Each of the sub pixels R_PX, G_PX, B_PX, and W_PX displays an element of an image in response to the data voltage.

The signal controller 600 receives first image signals R, G, and B and external control signals DE, Vsync, Hsync, and Mclk for controlling the display of the first image signals, and outputs a second image signal IDAT, a gate control signal CONT1, and a data control signal CONT2.

Specifically, the signal controller 600 may convert the first image signals R, G, and B into the second image signals IDAT, and output the converted signals. The second image signal IDAT may be converted from the first image signals R, G, and B in order to improve display quality. The second image signal IDAT may be converted from the first image signals R, G, and B in order to perform, for example, overdriving. Overdriving is well known, and therefore a detailed description of overdriving is omitted.

The signal controller 600 may receive the external control signals Vsync, Hsync, Mclk, and DE from an external source (not shown), and generate the gate control signal CONT1 and the data control signal CONT2. Examples of the external control signals include a data enable signal DE, a vertical synchronization signal Vsync, a horizontal synchronization signal Hsync, and a main clock signal Mclk. The gate control signal CONT1 is used for controlling the operation of the gate driver 400, and the data control signal CONT2 is used for controlling the operation of the data driver 500.

The gate driver 400 may receive the gate control signal CONT1 from the signal controller 600 and apply gate signals to the gate lines G1 to G2n. The gate signal may be composed of a combination of a gate-on voltage Von and a gate-off voltage Voff supplied from the voltage generator 650. The gate control signal CONT1 is used for controlling the operation of the gate driver 400, and may include a vertical start signal that starts the operation of the gate driver 400, a gate clock signal that determines the output timing of the gate-on voltage, and an output enable signal that determines the pulse width of the gate-on voltage.

The data driver 500 may receive the second image signal IDAT and the data control signal CONT2 from the signal controller 600, and apply data voltages to the pixel electrodes PE of the sub pixels R_PX, G_PX, B_PX, and W_PX through the data lines D1 to D2m. The data voltage corresponds to the second image signal IDAT, and is supplied from the gray voltage generator 700. That is, the data voltage may be divided from a driving voltage AVDD by the gray voltage generator 700 according to the gray level of the second image signal IDAT. Therefore, the minimum value of the data voltage may be 0 volts and the maximum value thereof may be the driving voltage AVDD.

The data control signal CONT2 includes a signal for controlling the operation of the data driver 500. The signal for controlling the operation of the data driver 500 may include a horizontal start signal that starts the operation of the data driver 500 and an output instruction signal that instructs the data driver 500 to output of an image data voltage.

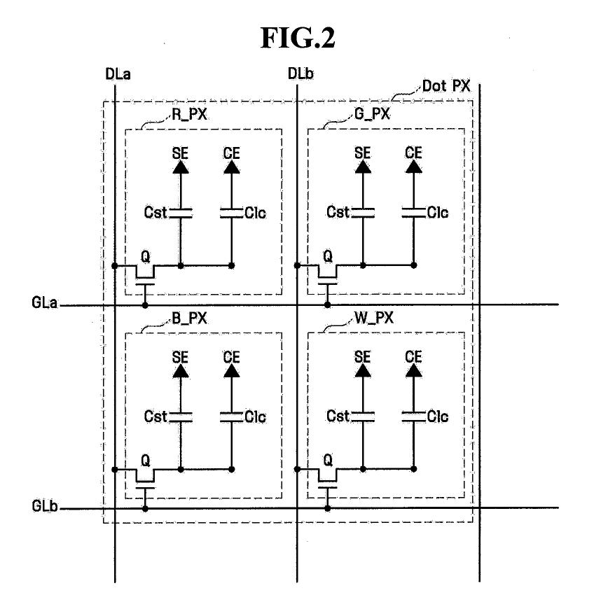

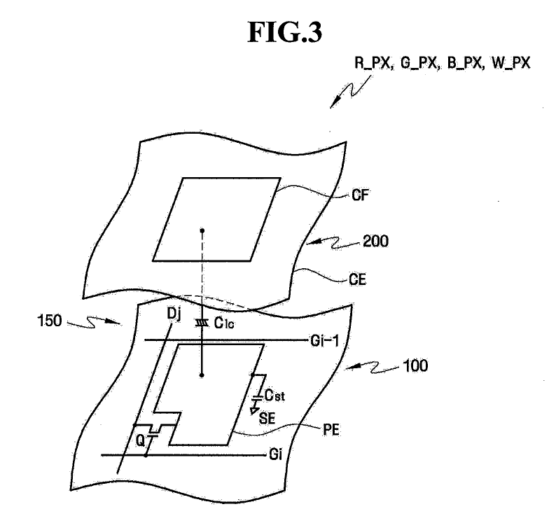

The voltage generator 650 may generate the gate-on voltage Von and the gate-off voltage Voff, and provide them to the gate driver 400. In addition, the voltage generator 650 may generate the driving voltage AVDD for the gray voltage generator 700, and provide it to the gray voltage generator 700. Further, the voltage generator 650 may generate a common voltage Vcom and a storage voltage Vst and supply them to a common electrode (see CE in FIGS. 2 and 3) and storage electrodes (see SE in FIGS. 2 and 3) of the liquid crystal panel 300, respectively.

The gray voltage generator 700 may supply the voltage divided from the driving voltage AVDD according to the gray level of the second image signal IDAT. The gray voltage generator 700 includes a plurality of resistors that are connected in series to each other between a node to which the driving voltage AVDD is applied and ground, and it may divide the voltage level of the driving voltage AVDD to generate a plurality of gray voltages. The internal circuit of the gray voltage generator 700 is not limited to that described above, but various other internal circuits may be used.

FIG. 2 is an equivalent circuit diagram of one dot pixel Dot PX included in the liquid crystal panel shown in FIG. 1, and FIG. 3 is an equivalent circuit diagram of one of the sub pixels R_PX, G_PX, B_PX, and W_PX included in the dot pixel Dot PX shown in FIG. 2.

Referring to FIG. 2, each dot pixel Dot PX may be divided into sub pixels R_PX, G_PX, B_PX, and W_PX that are arranged in a 2×2 matrix. The sub pixels R_PX, G_PX, B_PX, and W_PX may be arranged in four regions that are formed at intersections of two adjacent gate lines, that is, a first gate line GLa (a=1, 3, 5, . . . , 2n−1) and a second gate line GLb (b=2, 4, 6, . . . , 2n), and two adjacent data lines, that is, a first data line DLa (a=1, 3, 5, . . . , 2m−1) and a second data line DLb (b=2, 4, 6, . . . , 2m).

As shown in FIG. 2, in particular, each dot pixel Dot PX may be divided into an R sub pixel R_PX, a G sub pixel G_PX, a B sub pixel B_PX, and a W sub pixel W_PX. As described below, since each dot pixel Dot PX includes the W sub pixel W_PX, it is possible to improve the brightness of the display. Next, full white display, in which all pixels are turned on, will be described in detail and the brightness of this embodiment will be compared with the brightness of a comparative example in which each of the dot pixels Dot PX includes only the R sub pixel R_PX, the G sub pixel G_PX, and the B sub pixel B_PX.

In the comparative example, during full white display, each of the R sub pixel R_PX, the G sub pixel G_PX, and the B sub pixel B_PX can transmit about one-third of the light that is incident upon that sub pixel. When the area of the aperture of the dot pixel Dot PX is taken as 1 and each of the sub pixels R_PX, G_PX, and B_PX accounts for one-third of the area of the aperture, the amount of light passing through the R sub pixel R_PX is ⅓×⅓= 1/9, or one ninth of the light that is incident on the aperture of the dot pixel Dot PX. Similarly, each of the G sub pixel G_PX and the B sub pixel B_PX transmits one-ninth of the incident light. Therefore, in the comparative example, the amount of light passing through the dot pixel Dot PX is 1/9+ 1/9+ 1/9=⅓, or one third of the incident light.

In the present embodiment of the invention, when the area of an aperture of the dot pixel Dot PX is taken as 1 and each of the sub pixels R_PX, G_PX, B_PX, and W_PX accounts for one-fourth of the area of the aperture, the amount of light passing through the R sub pixel R_PX is ¼×⅓= 1/12, or one twelfth of the light incident upon the aperture of the dot pixel Dot PX. Similarly, each of the G sub pixel G_PX and the B sub pixel B_PX transmits one-twelfth of the incident light. However, since the W sub pixel W_PX can transmit almost all incident light, the amount of light passing through the W sub pixel W_PX is ¼×1=¼ or one quarter of the light incident upon the aperture of the dot pixel Dot PX. Therefore, in this embodiment, the amount of light passing through the dot pixel Dot PX is 1/12+ 1/12+ 1/12+¼=½ or one half of the incident light.

That is, when the dot pixel Dot PX of the present embodiment displays full white, the brightness is improved by 50%, when comparing this embodiment in which the dot pixel transmits half the incident light with the comparative example in which the dot pixel transmits one-third of the incident light.

Referring to FIGS. 2 and 3, each of the sub pixels R_PX, G_PX, B_PX, and W_PX, includes a pixel electrode PE that is connected to an i-th (i=1 to 2n) gate line G1 and to a j-th (j=1 to 2m) data line Dj. Each sub pixel may include a switching element Q that is connected to the gate line G1 and the data line Dj, and may include a liquid crystal capacitor Clc and a storage capacitor Cst that are connected to the switching element Q. As shown in FIGS. 2 and 3, the liquid crystal capacitor Clc may be composed of two electrodes, for example, the pixel electrode PE on the first display panel 100 and the common electrode CE on the second display panel 200 and liquid crystal layer 150 interposed between the two electrodes. The storage electrode SE may form the storage capacitor Cst together with the pixel electrode PE of the sub pixel R_PX, G_PX, B_PX, or W_PX. Furthermore, each sub pixel includes a color filter CF that is formed on a portion of the common electrode CE opposite the pixel electrode PE.

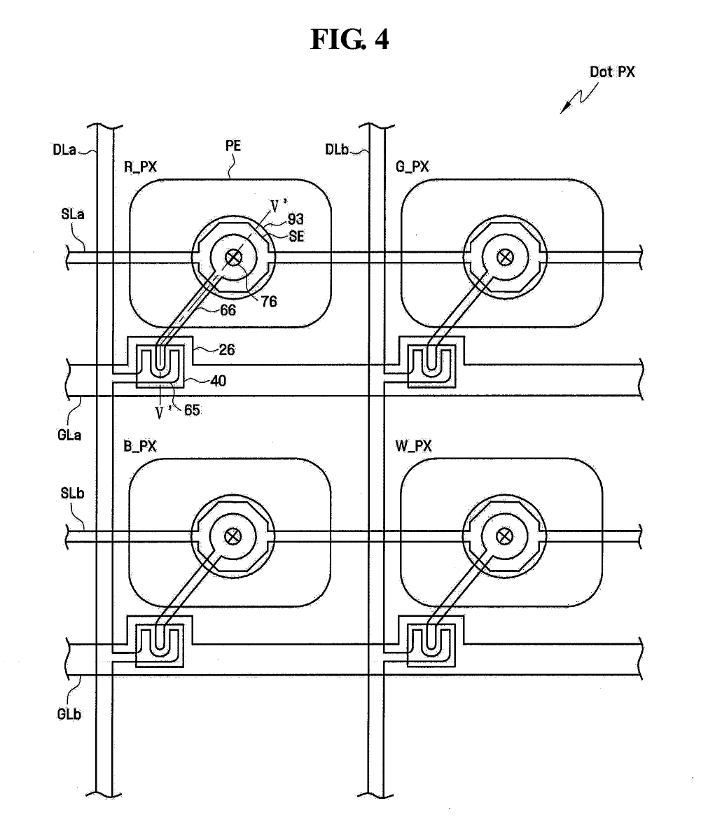

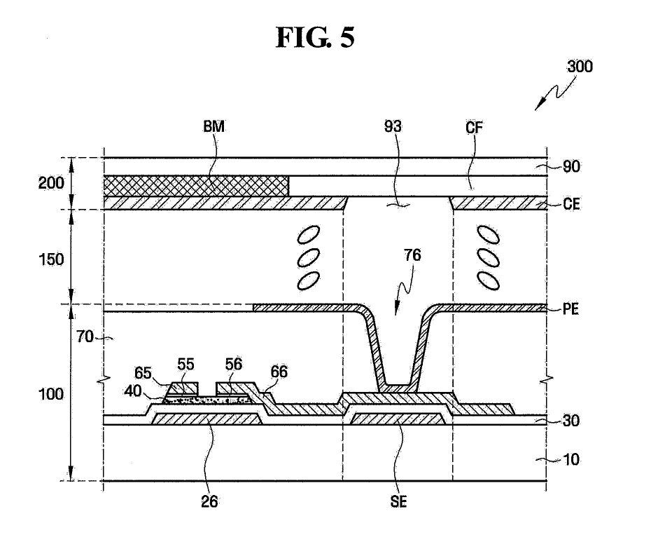

Next, the liquid crystal panel 300 shown in FIG. 1 will be described in detail with reference to FIGS. 4 and 5. FIG. 4 is a layout diagram illustrating one dot pixel Dot PX included in the liquid crystal panel shown in FIG. 1, and FIG. 5 is a cross-sectional view of a portion of the sub pixel R_PX taken along the line V-V′ of FIG. 4. The sub pixels G_PX, B_PX, and W_PX are similar to the sub pixel R_PX and have cross sections similar to that shown in FIG. 5.

Referring to FIGS. 4 and 5, the liquid crystal panel 300 includes the first display panel 100 having a thin film transistor array formed thereon, the second display panel 200 that is opposite to the first display panel 100 and has the common electrode CE formed thereon, and the liquid crystal layer 150 that is interposed between the first display panel 100 and the second display panel 200.

First, the first display panel 100 includes a first insulating substrate 10 made of, for example, transparent glass. Gate lines GLa and GLb that transmit gate signals are formed on the insulating substrate 10 and extend substantially in the horizontal direction. Gate lines GLa are allocated to rows of sub pixels R_PX and G_PX, gate lines GLb are allocated to rows of sub pixels B_PX, or W_PX, and protruding gate electrodes 26 are formed on each of the gate lines GLa and GLb. The gate lines GLa and GLb and the gate electrodes 26 are referred to as a gate wiring line (GLa, GLb, and 26). Other arrangements of the four sub pixels and the allocations of gate lines to specific sub pixels are possible and fall within the scope of the present invention.

Storage lines SLa and SLb may be formed on the insulating substrate 10. The storage lines SLa and SLb extend in the horizontal direction so as to be substantially parallel to the gate lines GLa and GLb, and transmit storage voltages to the storage electrodes SE. The storage electrode SE may form the storage capacitor Cst together with the pixel electrode PE of the sub pixel R_PX, G_PX, B_PX, or W_PX. The storage lines SLa and SLb and the storage electrodes SE are referred to as a storage wiring line (SLa, SLb, and SE).

As shown in FIGS. 4 and 5, the storage electrodes SE may be formed at positions corresponding to the positions of cutout patterns 93 that are formed in the common electrode CE. The positioning of the storage electrodes SE in regions corresponding to the cutout patterns 93 formed in the common electrode CE does not affect the aperture ratio of the liquid crystal panel 300, as will be described below. It is possible to prevent a reduction in the aperture ratio caused by the storage electrode SE by forming the storage electrode SE at a position corresponding to the cutout pattern 93, in which position the storage electrode does not affect the aperture ratio.

In particular, the storage electrode SE may be formed in a portion of a metal layer of the gate electrode 26, the storage electrode SE being below a contact hole 76 so as to overlap the contact hole 76.

In addition, the storage electrode SE may be equal to or smaller than the cutout pattern 93 in size. As such, the storage electrode SE formed to have a size similar to the size of the cutout pattern 93 makes it possible to ensure that the storage electrode SE has a predetermined area or more as required for the storage capacitor Cst while preventing a reduction in the aperture ratio. Alternatively, the storage lines SLa and SLb and the storage electrodes SE may be omitted.

The gate wiring line (GLa, GLb, and 26) and the storage wiring line (SLa, SLb, and SE) may be formed of an aluminum-based metallic material, such as aluminum (Al) or aluminum alloy, a silver-based metallic material, such as silver (Ag) or silver alloy, a copper-based metallic material, such as copper (Cu) or copper alloy, a molybdenum-based metallic material, such as molybdenum (Mo) or molybdenum alloy, chromium (Cr), titanium (Ti), or tantalum (Ta). In addition, the gate wiring line (GLa, GLb, and 26) may have a multi-layer structure of two conductive films (not shown) having different physical properties. One of the two conductive films is formed of low-resistivity metal, such as aluminum-based metal, silver-based metal, or copper-based metal, in order to reduce a signal delay or a voltage drop in the gate wiring line (GLa, GLb, and 26). The other conductive film is formed of a material different from the above, particularly, a material having desirable contact characteristics with ITO (indium tin oxide) and IZO (indium zinc oxide), such as molybdenum-based metal, chromium, titanium, or tantalum. As preferred examples of the two-layer structure, a laminate of a lower chromium film and an upper aluminum film or a laminate of a lower aluminum film and an upper molybdenum film may be used.

A gate insulating film 30 made of, for example, silicon nitride (SiNx) or silicon oxide (SiOx) is formed on the gate lines GLa and GLb.

An active layer 40 made of, for example, hydrogenated amorphous silicon or polycrystalline silicon is formed on the gate insulating film 30. The active layer 40 may be formed in various shapes, such as an island shape and a linear shape. In this embodiment, the active layer 40 is formed in the island shape as shown in FIG. 4.

The ohmic contact layers 55 and 56 made of silicide or made of silicon that is highly doped with n-type impurities, such as n+ hydrogenated amorphous silicon, are formed on the active layer 40. A pair of ohmic contact layers 55 and 56 is formed on the active layer 40.

The data lines DLa and DLb and the drain electrodes 66 corresponding to the data lines DLa and DLb are formed on the ohmic contact layers 55 and 56 and the gate insulating film 30.

The data lines DLa and DLb extend substantially in the vertical direction to intersect the gate lines GLa and GLb, respectively, and transmit the data voltage. Source electrodes 65 are formed on the data lines DLa and DLb so as to extend toward the drain electrodes 66. The data lines DLa and DLb transmit data signals to the pixel electrodes PE. The data lines DLa and DLb, the source electrodes 65, and the drain electrodes 66 are referred to as data wiring lines.

The data wiring lines (DLa, DLb, 65, and 66) are preferably formed of refractory metal, such as chromium, molybdenum-based metal, tantalum, or titanium, and may have a multi-layer structure of a lower film (not shown) formed of refractory metal and an upper film (not shown) formed of a low-resistance material. The multi-layer structure includes, for example, a two-layer structure of a lower chromium film and an upper aluminum film, a two-layer structure of a lower aluminum film and an upper molybdenum film, and a three-layer structure of a molybdenum film, an aluminum film, and a molybdenum film.

At least a portion of the source electrode 65 overlaps the active layer 40. The drain electrode 66 is opposite to the source electrode 65 with the gate electrode 26 interposed therebetween, and at least partially overlaps the active layer 40. The ohmic contact layers 55 and 56 are interposed between the active layer 40 and the source and drain electrodes 65 and 66 to reduce the contact resistance therebetween.

Also, the drain electrode 66 has one end that faces the source electrode 65 and the other end that has a large area and is electrically connected to the pixel electrode PE in a manner which will be described below.

A passivation layer 70 is formed on the data wiring lines (DLa, DLb, 65, and 66) and the exposed active layer 40. The passivation layer 70 is made of, for example, an inorganic material consisting of silicon nitride or silicon oxide, an organic material having a high planarizing property and photosensitivity, or a low dielectric insulating material, such as a-Si:C:O or a-Si:O:F formed by plasma enhanced chemical vapor deposition (PECVD). The passivation layer 70 may have a two-layer structure of a lower inorganic film and an upper organic film in order to protect the exposed active layer 40 while maintaining desirable characteristics of the organic film. Further, a red, green, or blue color filter layer may be used as the passivation layer 70.

Contact holes 76 are formed in the passivation layer 70. The pixel electrode PE is physically and electrically connected to the drain electrode 66 through the contact hole 76 to be supplied with a data voltage. That is, the contact hole 76 electrically connects the drain of thin film transistor Q to the pixel electrode PE of a sub pixel R_PX, G_PX, B_PX, or W_PX.

As shown in FIGS. 4 and 5, the contact hole 76 may be disposed at the center of each of the sub pixels R_PX, G_PX, B_PX, and W_PX. Also, as shown in FIGS. 4 and 5, each contact hole 76 may be formed at a position corresponding to the position of the cutout pattern 93 formed in the common electrode CE. A contact hole 76 formed in a region corresponding to the cutout pattern 93 formed in the common electrode CE does not affect the aperture ratio of the liquid crystal panel 300, as will be described below. It is possible to prevent a reduction in the aperture ratio caused by the contact hole 76 by forming the contact hole 76 at a position corresponding to each cutout pattern 93, in which position the contact hole does not affect the aperture ratio.

The contact hole 76 may be equal to or smaller in size than the cutout pattern 93, as shown in the drawings.

The pixel electrodes PE are formed on the passivation layer 70 so as to correspond to the shapes of the sub pixels R_PX, G_PX, B_PX, and W_PX. The pixel electrode PE of each of the sub pixels R_PX, G_PX, B_PX, and W_PX may be formed in a rectangular shape as shown in FIG. 4, but may be formed in various other shapes, such as a circular shape and a square shape. The pixel electrode PE may be formed of a transparent conductor, such as ITO or IZO, or a reflective conductor, such as aluminum.

In particular, the pixel electrode PE may be formed in a square shape. An aperture that is symmetrical with respect to the center of the cutout pattern 93, which will be described below, may be provided for each pixel electrode PE. It is possible to obtain a wide viewing angle in all directions by forming the aperture that is symmetrical with respect to the center of the cutout pattern 93 around the pixel electrode PE, which will be described below. An aperture that is symmetrical with respect to the center of the out pattern 93 is one that has a center that approximately coincides with the center of the cutout pattern 93. The aperture may have a shape that is substantially rectangular, circular or square or may have any other suitable shape. The shape and location of the aperture is largely determined by the shape and location of a pixel opening in a black matrix that is formed on the second display panel 200 and is described herein below.

The pixel electrode PE of each of the sub pixels R_PX, G_PX, B_PX, and W_PX has rounded corners. The pixel electrode PE having the rounded corners makes it possible to ensure continuity in the tilt of the liquid crystal molecules of the liquid crystal layer 150.

Next, the second display panel 200 will be described. A black matrix BM is formed on a second insulating substrate 90 in order to prevent light leakage and define pixel regions each of which includes a region in which the black matrix is absent. The insulating substrate 90 is made of a transparent material, for example, glass. The black matrix BM may be formed in portions corresponding to the gate lines GLa and GLb and the data lines DLa and DLb and portions corresponding to the thin film transistors. The black matrix BM may be formed in various shapes in order to prevent light leakage from the pixel electrodes PE and to prevent light from reaching the thin film transistors. The black matrix BM may be formed of an inorganic material including a metal or a metal oxide, such as chromium or chromium oxide, or alternatively the black matrix BM may be formed of an organic black resist.

The red, green, and blue and white color filters CF may be formed in the pixel regions in the black matrix BM at positions corresponding to the pixel electrodes PE of the sub pixels R_PX, G_PX, B_PX, and W_PX. The white filter may be formed of a transparent colorless organic film, or alternatively the white filter may be omitted. An overcoat layer (not shown) may be formed on the color filters CF to provide a surface free of step differences between the filters and the black matrix BM.

The common electrode CE made of a transparent conductive material, such as ITO or IZO, is formed on the overcoat layer (not shown). The common electrode CE faces the pixel electrodes PE of the sub pixels R_PX, G_PX, B_PX, and W_PX, and the liquid crystal layer 150 is interposed between the common electrode CE and the pixel electrodes PE. An alignment film (not shown) that aligns the molecules of the liquid crystal layer 150 may be formed on the common electrode CE.

The common electrode CE may include the cutout patterns 93 corresponding to the centers of the sub pixels R_PX, G_PX, B_PX, and W_PX. In FIG. 4, each of the cutout patterns 93 is an area in which the material of the common electrode is removed to form a hole that is circular in shape. The hole shape of the cutout patterns 93 ensures that the periphery of a portion of the common electrode CE that is penetrated is bounded by a closed curve. The cutout pattern 93 may have various other shapes, such as a rectangular shape or other suitable shape.

The cutout pattern 93 alters the direction of an electric field to align molecules of the liquid crystal layer 150 in a predetermined direction, when a voltage is applied between the pixel electrode PE and the common electrode CE. When a voltage is applied between the common electrode CE and the pixel electrode PE, an electric field is formed that has a component in a radial direction near the cutout pattern 93, since the voltage is not directly applied to the cutout pattern 93. Therefore, the molecules of the liquid crystal layer 150 are inclined toward the periphery of the cutout pattern 93. That is, the liquid crystal molecules are radially inclined toward the cutout pattern 93. For this reason, the storage electrode SE and/or the contact hole 76 arranged at a position corresponding to the position of the cutout pattern 93 do not affect the aperture ratio of the liquid crystal panel 300.

The first display panel 100 and the second display panel 200 having the above-mentioned structures are bonded to each other while being aligned with each other, and the liquid crystal layer 150 is injected therebetween and the molecules of the liquid crystal layer 150 are aligned in the vertical direction, i.e. perpendicular to the first display panel and to the second display panel, thereby forming the basic structure of the liquid crystal panel 300.

When no electric field is applied between the pixel electrodes PE and the common electrode CE, the molecules of the liquid crystal layer 150 are aligned such that their directors are vertical to the first display panel 100 and the second display panel 200, and have negative dielectric anisotropy.

When a voltage is applied between the pixel electrodes PE and the common electrode CE, a vertical electric field is formed in almost all the regions between the first display panel 100 and the second display panel 200 except in the vicinity of cutout patterns 93.

When a vertical electric field is formed between the common electrode and a pixel electrode, a horizontal electric field is formed in the vicinities of the cutout patterns 93 of the common electrode CE. The horizontal electric field alters the alignment of the molecules of liquid crystal layer 150 in the vicinity of cutout patterns 93.

When an electric field is applied between the first display panel 100 and the second display panel 200, the molecules of the liquid crystal layer 150 have negative dielectric anisotropy.

The molecules of the liquid crystal layer 150 in each of the sub pixels R_PX, G_PX, B_PX, and W_PX are inclined toward the cutout pattern 93 such that the molecules on one side of the cutout pattern 93 tilt in an opposite direction to the molecules on the other side of the cutout pattern 93. Also, as described above, the pixel electrode PE may have a square shape in particular, and an aperture that is symmetrical with respect to the center of the cutout pattern 93 may be provided for each pixel electrode PE.

Therefore, the molecules of the liquid crystal layer 150 are radially inclined toward the center of the cutout pattern 93 at an angle of 45° or −45° with respect to the plane of the gate lines GLa and GLb. Optical characteristics are compensated by the molecules of the liquid crystal layer 150 that are radially inclined toward the center of the cutout pattern 93. As a result, it is possible to obtain a wide viewing angle in all directions.

In this embodiment, each of the thin film transistors Q may be an a-Si thin film transistor. In order to increase the resolution of the liquid crystal panel 300, it is necessary to reduce the area of each dot pixel Dot PX and thereby increase the number of dot pixels Dot PX per inch. Advantageously, according to this embodiment, even when the area of each dot pixel Dot PX is reduced, it is possible to prevent a reduction in the aperture ratio due to the storage electrode SE or the contact hole 76, and thus obtain a wide viewing angle in all directions. Therefore, even when the area of each dot pixel Dot PX is reduced to increase the resolution, it is possible to achieve a liquid crystal panel 300 having a high aperture ratio and a wide viewing angle. That is, according to this embodiment, it is possible to achieve an a-Si thin film transistor liquid crystal display device having a very small pixel size and having a corresponding very high density of pixels, for example, 220 ppi (pixels per inch) or more, or even 300 ppi or more.

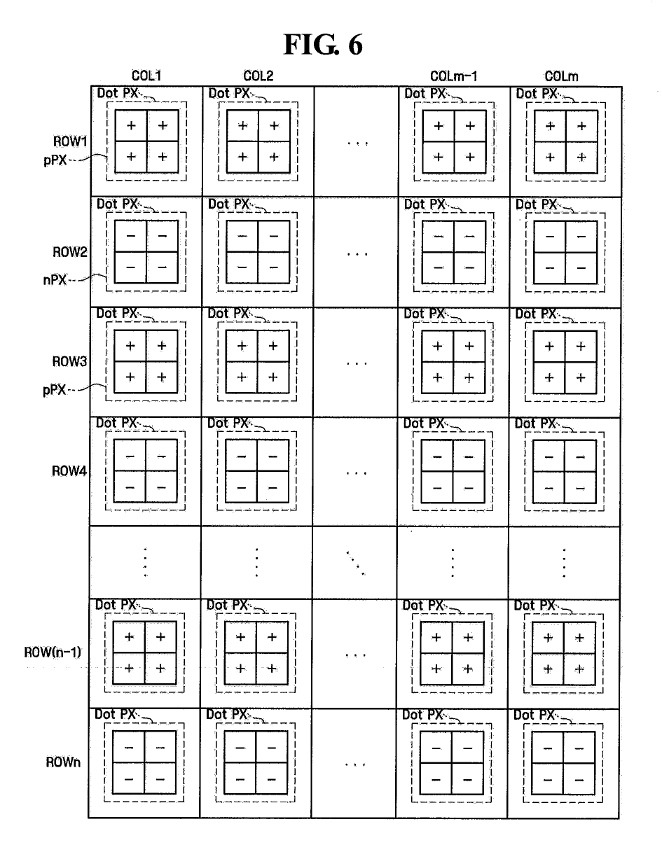

FIG. 6 is a diagram illustrating an inversion driving method of the liquid crystal panel shown in FIG. 1.

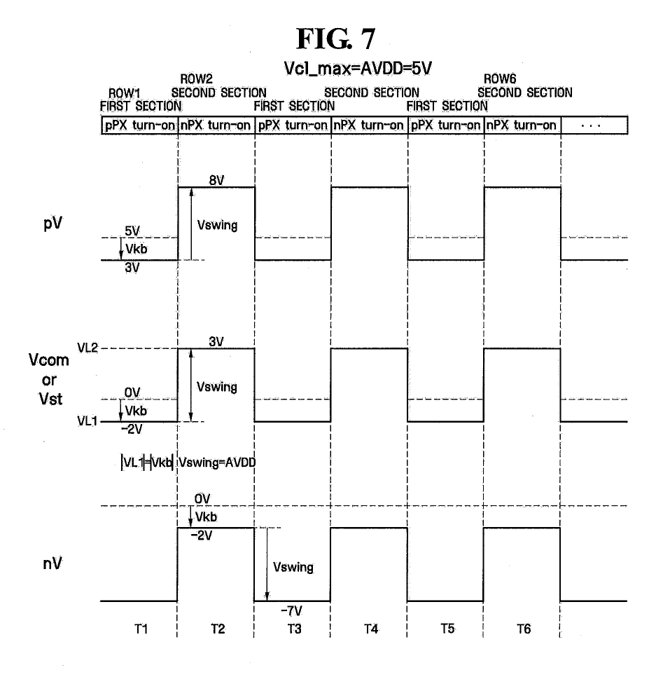

In FIG. 6, dot pixels Dot PX are arranged in rows ROW1 to ROWn and in columns COL1 to COLm in a dot pixel (Dot PX) array of the liquid crystal panel 300 shown in FIG. 1. Four rectangles included in each dot pixel Dot PX indicate the locations of the sub pixels R_PX, G_PX, B_PX, and W_PX. In odd numbered rows, ROW1 through ROW(n−1), the symbol ‘+’ in the four rectangles indicate that a positive data voltage is applied to the sub pixels R_PX, G_PX, B_PX, and W_PX during a frame. In even numbered rows, ROW2 through ROWn, the symbol ‘−’ in the four rectangles indicate that a negative data voltage is applied to the sub pixels R_PX, G_PX, B_PX, and W_PX during that frame. The positive voltage (see pV in FIG. 7) means a voltage that is higher than the common voltage Vcom applied to the common electrode, and the negative voltage (see nV in FIG. 7) means a voltage that is lower than the common voltage Vcom.

The dot pixels Dot PX may be classified into positive dot pixels pPX and negative dot pixels nPX that are alternately turned on, which makes it possible to perform inversion driving. The positive dot pixels pPX are in odd rows, ROW1 through ROWn. The negative dot pixels are in even rows ROW2 through ROWn. In normal operation, a scanning signal is applied to rows ROW1 through ROWn sequentially in time so that the thin film transistors Q in each row are turned on and the data voltages are applied to the pixel electrodes. In any frame, the sub pixels R_PX, G_PX, B_PX, and W_PX included in the positive dot pixels pPX receive a data voltage of one polarity and the sub pixels R_PX, G_PX, B_PX, and W_PX included in the negative dot pixels nPX receive a data voltage of the other polarity.

For example, the liquid crystal panel 300 may be driven in such a manner that, in one frame, data voltages having one polarity are applied to odd-numbered rows of dot pixels Dot PX, and in the next frame, data voltages having an opposite polarity are applied to the odd-numbered rows of dot pixels Dot PX.

That is, the data voltages having the polarities shown in FIG. 6 are applied in one frame, and data voltages having polarities opposite to the polarities shown in FIG. 6 are applied in the next frame. In this way, inversion driving is performed in which the polarity of data voltages applied to rows of dot pixels Dot PX in one frame is the opposite of the polarity of the data voltages applied to rows of dot pixels Dot PX in the next frame.

FIG. 7 is a timing chart illustrating a method of driving the array of dot pixels shown in FIG. 6.

The term “FIRST SECTION” in FIG. 7 includes the odd number rows ROW1 through ROW(n−1) in FIG. 6 containing positive dot pixels pPX. The term “SECOND SECTION” in FIG. 7 includes the even numbered rows ROW2 through ROWn as shown in FIG. 6 that contain negative dot pixels nPX.

FIG. 7 shows a method of driving the positive dot pixels pPX and the negative dot pixels nPX shown in FIG. 6 when the maximum liquid crystal voltage Vcl_max of the liquid crystal molecules 150 is equal to the maximum value of the data voltage. The maximum liquid crystal voltage Vcl_max means a voltage to fully turn on the liquid crystal molecules 150. As described above with reference to FIG. 1, an example in which the minimum value of the data voltage supplied by the data driver 500 is 0 V and the maximum value thereof is the driving voltage AVDD of the gray voltage generator 700 will be described below. It is assumed that the maximum value of the data voltage, that is, the driving voltage AVDD of the gray voltage generator 700 is 5 V for clarity of description.

The dot pixels Dot PX may be classified into the positive dot pixels pPX and the negative dot pixels nPX that are alternately turned on, which makes it possible to perform inversion driving. In ROW1 in the first section, in a first time period T₁, the positive dot pixels pPX are turned on, i.e. connected to the data lines by turning on the thin film transistors Q in the sub pixels in ROW1. In ROW2 of the second section, in the second time period T₂ the negative dot pixels nPX are turned on. Next, a method of fully turning on the liquid crystal molecules between the positive dot pixels pPX and the common electrode CE and the liquid crystal molecules between the negative dot pixels nPX and the common electrode CE will be described.

In ROW1 in the first section, in the first time period T₁, a maximum data voltage of 5 V is applied to the positive dot pixels pPX. Then, in ROW2 in the second section, in the second time period T₂, a minimum data voltage of 0V is applied to the negative dot pixels nPX. In odd numbered time periods T₃, T₅ and so on the maximum data voltage of 5 volts is applied to ROW3, ROW5, and so on. In even numbered time periods T₄, T₆ and so on to Tₙ a minimum data voltage of 0V is applied to rows ROW4, ROW6 and so on to ROWn.

However, according to this embodiment of the invention, the capacitance of the storage capacitor Cst may be reduced or the storage capacitor Cst may be removed. In this case, a kick-back voltage Vkb may increase. In the following description, it is assumed that the kick-back voltage Vkb is, for example, 2 V for clarity of description. The kick-back voltage Vkb causes the voltage level pV of the positive dot pixels pPX to be 3 V (=5 V−2 V) in the first section, and the voltage level nV of the negative dot pixels nPX to be −2 V (=0 V−2 V) in the second section.

Meanwhile, the common voltage Vcom swings between a first level VL1 and a second level VL2 in the first and second sections. A swing voltage Vswing, which is a difference between the first level VL1 and the second level VL2, is 5 V, which is the maximum value of the data voltage, that is, the driving voltage AVDD of the gray voltage generator 700.

The first level VL1 of the common voltage Vcom is −2 V, which is obtained by subtracting the kick-back voltage Vkb from the ground level (0 V), and the second level VL2 of the common voltage Vcom is 3 V, which is obtained by adding the first level VL1 to 5 V, which is the maximum value of the data voltage, that is, the driving voltage AVDD of the gray voltage generator 700.

In this way, it is possible to maintain the voltage between the positive dot pixel pPX and the common electrode CE and the voltage between the negative dot pixel nPX and the common electrode CE to be the maximum liquid crystal voltage Vcl_max in the first and second sections, respectively. Therefore, it is possible to fully turn on both the liquid crystal molecules between the positive dot pixels pPX and the common electrode CE and the liquid crystal molecules between the negative dot pixels nPX and the common electrode CE in the first and second sections.

Briefly, in the driving method shown in FIG. 7, in the first section, the voltage level VL1 of the common voltage Vcom is equal to the kick-back voltage Vkb, and the swing voltage Vswing of the common voltage Vcom is equal to the maximum value of the data voltage, that is, the driving voltage AVDD of the gray voltage generator 700.

In the next frame after the frame shown in FIG. 7 positive data voltages are applied to the nPX dot pixels in the second section and negative data voltages are applied to the positive dot pixels pPX in the first section.

Although only the common voltage Vcom has been described above, the above description may be applied to the storage voltage Vst.

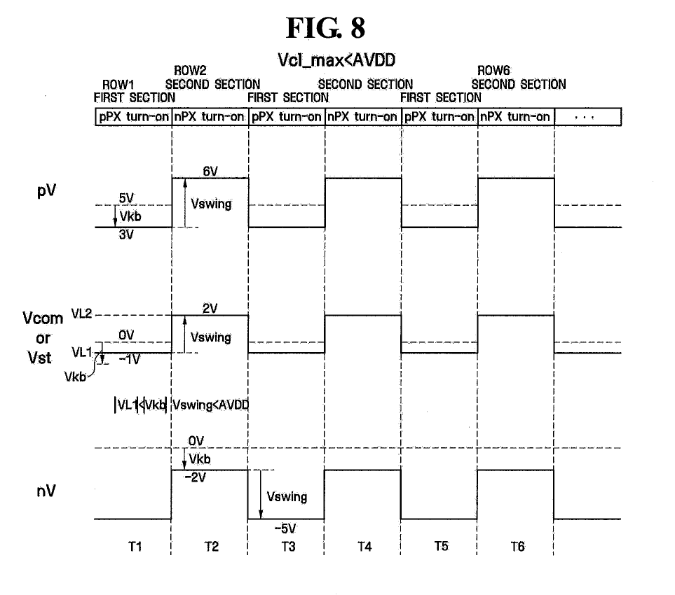

FIG. 8 is a timing chart illustrating another method of driving the positive dot pixels and the negative dot pixels shown in FIG. 6. In this method, the storage voltage Vst having the same waveform as the common voltage Vcom may be applied to the storage electrode SE, similarly to the method illustrated in FIG. 7.

FIG. 8 shows a method of driving the positive dot pixels pPX and the negative dot pixels nPX shown in FIG. 6 when the maximum liquid crystal voltage Vcl_max of the liquid crystal molecules 150 is lower than the maximum value of the data voltage. Similarly, an example in which the minimum value of the data voltage supplied by the data driver 500 is 0 V and the maximum value thereof is the driving voltage AVDD of the gray voltage generator 700 will be described below. It is assumed that the maximum value of the data voltage, that is, the driving voltage AVDD of the gray voltage generator 700 is 5 V for clarity of description. In addition, it is assumed that the maximum liquid crystal voltage Vcl_max of the liquid crystal molecules 150 is 4 V that is lower than 5 V, which is the maximum value of the data voltage.

In ROW1 in the first section, a maximum data voltage of 5 V is applied to the positive dot pixels pPX in time period T₁, and the dot pixels in all other rows are turned off. Then, in ROW2 in the second section, a minimum data voltage of 0 V is applied to the negative dot pixels nPX in time period T₂ and the dot pixels in all other rows are turned off. In the third time period T₃ maximum data voltage of 5 V is applied to the positive dot pixels pPX in ROW3. In the fourth time period T₄ the minimum data voltage of 0 V is applied to the negative dot pixels in ROW4 and so on till a frame is completed. Similar to FIG. 7, the kick-back voltage Vkb causes the voltage level pV of the positive dot pixels pPX to be 3 V (=5 V−2 V) in the first section, and the voltage level nV of the negative dot pixels nPX to be −2 V (=0 V−2 V) in the second section.

Meanwhile the common voltage Vcom swings between the first level VL1 and the second level VL2 in the first and second sections.

A swing voltage Vswing may be obtained by subtracting a difference between the maximum value of the data voltage and the maximum liquid crystal voltage Vcl_max from the maximum liquid crystal voltage Vcl_max (that is, the swing voltage Vswing=the maximum liquid crystal voltage Vcl_max−{AVDD—the maximum liquid crystal voltage Vcl_max}). For example, the swing voltage Vswing may be 3 V, a value that is lower than the maximum liquid crystal voltage Vcl_max.

The first level VL1 of the common voltage Vcom is −1 V that is obtained by subtracting −1 V, which is lower than the kick-back voltage Vkb, from the ground level (0 V), and the second level VL2 of the common voltage Vcom is 2 V that is obtained by adding 3 V, which is lower than the maximum liquid crystal voltage Vcl_max, to the first level VL1.

In this way, it is possible to maintain the voltage between the positive dot pixel pPX and the common electrode CE and the voltage between the negative dot pixel nPX and the common electrode CE to be the maximum liquid crystal voltage Vcl_max in the first and second sections. Therefore, it is possible to fully turn on both the liquid crystal molecules between the positive dot pixels pPX and the common electrode CE and the liquid crystal molecules between the negative dot pixels nPX and the common electrode CE in the first and second sections.

Briefly, in the driving method shown in FIG. 8, in the first section, the voltage level VL1 of the common voltage Vcom is lower than the kick-back voltage Vkb, and the swing voltage Vswing of the common voltage Vcom is also lower than the maximum value of the data voltage. Therefore, when low-voltage liquid crystal having the maximum liquid crystal voltage Vcl_max that is lower than the maximum voltage AVDD of the data driver 500 is used and the driving method shown in FIG. 8 is used, it is possible to reduce the load of the voltage generator 650 and reduce power consumption, as compared to the driving method shown in FIG. 7.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A liquid crystal display device comprising:
a first display panel including dot pixels each of which is divided into sub pixels arranged in a 2×2 matrix;
a second display panel including a common electrode that includes cutout patterns disposed at locations corresponding to the centers of the sub pixels; and
a liquid crystal layer interposed between the first display panel and the second display panel.

2. The liquid crystal display device of claim 1, wherein the first display panel further includes:
thin film transistors configured for turning on the sub pixels; and
contact holes electrically connecting the thin film transistors to pixel electrodes of the sub pixels, the contact holes being formed at positions corresponding to the cutout patterns.

3. The liquid crystal display device of claim 2, wherein the size of each of the contact holes is equal to or smaller than the cutout pattern.

4. The liquid crystal display device of claim 1, wherein:
the pixel electrode of each of the sub pixels has a square shape; and
an aperture that is symmetrical with respect to the center of the cutout pattern is provided for each of the pixel electrodes.

5. The liquid crystal display device of claim 1, wherein the first display panel further includes storage electrodes that form storage capacitors together with the pixel electrodes of the sub pixels, each of the storage electrodes being formed at a position corresponding to the cutout pattern.

6. The liquid crystal display device of claim 5, wherein the size of each of the storage electrodes is equal to or smaller than the cutout pattern.

7. The liquid crystal display device of claim 1, wherein the pixel electrode of each of the sub pixels has rounded corners.

8. The liquid crystal display device of claim 1, wherein each of the dot pixels is divided into a red sub pixel, a green sub pixel, a blue sub pixel, and a white sub pixel.

9. The liquid crystal display device of claim 1, wherein:
the dot pixels are classified into positive dot pixels and negative dot pixels that are alternately turned on, thereby performing inversion driving; and
wherein data voltages of one polarity are applied to the sub pixels of the positive dot pixels, and data voltages of an opposite polarity are applied to the sub pixels of the negative dot pixels.

10. The liquid crystal display device of claim 1, wherein:
the first display panel further includes a-Si thin film transistors that turn on the sub pixels; and
the number of dot pixels per inch is 220 or more.

11. A liquid crystal display device comprising:
dot pixels each of which is divided into sub pixels arranged in a 2×2 matrix;
thin film transistors for turning on the sub pixels; and
contact holes electrically connecting the thin film transistors to pixel electrodes of the sub pixels, the contact holes being formed at the centers of the sub pixels.

12. The liquid crystal display device of claim 11, further comprising a common electrode facing the pixel electrodes of the sub pixels, the common electrode including cutout patterns that are formed in hole shapes to correspond to the centers of the sub pixels.

13. The liquid crystal display device of claim 12, wherein:
the pixel electrode of each of the sub pixels has a square shape; and
an aperture that is symmetrical with respect to the center of the cutout pattern is formed around each of the pixel electrodes.

14. The liquid crystal display device of claim 11, further comprising storage electrodes forming storage capacitors together with the pixel electrodes of the sub pixels, each of the storage electrodes being formed so as to overlap the corresponding contact hole.

15. The liquid crystal display device of claim 11, wherein each of the dot pixels is divided into a red sub pixel, a green sub pixel, a blue sub pixel, and a white sub pixel.

16. A liquid crystal display device comprising:
dot pixels each of which is divided into sub pixels arranged in a 2×2 matrix;
a common electrode facing the pixel electrodes of the sub pixels and including cutout patterns that are formed so as to correspond to the centers of the sub pixels;
a data driver applying a data voltage to the pixel electrodes of the sub pixels; and
a liquid crystal layer interposed between the pixel electrodes of the sub pixels and the common electrode,
wherein the dot pixels are classified into positive dot pixels and negative dot pixels that are alternately turned on, thereby performing inversion driving,
a maximum liquid crystal voltage that allows the liquid crystal molecules to be fully turned on is lower than a maximum value of the data voltage, and
a common voltage applied to the common electrode has a swing voltage that is lower than the maximum liquid crystal voltage.

17. The liquid crystal display device of claim 16, wherein the swing voltage is equal to a voltage obtained by subtracting a difference between the maximum value of the data voltage and the maximum liquid crystal voltage from the maximum liquid crystal voltage.

18. The liquid crystal display device of claim 16, further comprising storage electrodes forming storage capacitors together with the pixel electrodes of the sub pixels, wherein a storage voltage having the same waveform as the common voltage is applied to each of the storage electrodes.

19. The liquid crystal display device of claim 16, wherein:
in order to maintain a voltage between the positive dot pixels and the common electrode and a voltage between the negative dot pixels and the common electrode to be the maximum liquid crystal voltage;
in a first section in which the positive dot pixels are turned on and the negative dot pixels are turned off, a voltage applied to the positive dot pixels is equal to the maximum value of the data voltage;
in a second section in which the negative dot pixels are turned on and the positive dot pixels are turned off, a voltage applied to the negative dot pixels is equal to a minimum value of the data voltage; and
the common voltage has a first level in the first section and a second level that is higher than the first level by the swing voltage in the second section.

20. The liquid crystal display device of claim 19, wherein a difference between the ground level and the first level is lower than a kick-back voltage that is generated when the data voltage is applied to the positive dot pixels or the negative dot pixels.
